(19) United States
(12) Patent Application Publication
(10) Pub. No.: US 2018/0126977 A1
(43) Pub. Date: May 10, 2018

(54) METHOD FOR CONTROLLING DRIVING OF VEHICLE USING DRIVING INFORMATION OF FORWARD VEHICLE

(71) Applicant: HYUNDAI MOTOR COMPANY, Seoul (KR)

(72) Inventor: Do Hee KIM, Seongnam-si (KR)

(73) Assignee: HYUNDAI MOTOR COMPANY, SEOUL (KR)

(21) Appl. No.: 15/485,519

(22) Filed: Apr. 12, 2017

(30) Foreign Application Priority Data
Nov. 8, 2016 (KR) 10-2016-0148373

(51) Int. Cl. B60W 20/15; G05D 1/02; G08G 1/00

(52) U.S. Cl. CPC B60W 20/15; G05D 1/0293; G08G 1/22; G05D 1/0276; B60W 2720/24; B60W 2710/06; Y10S 903/903; B60W 2750/40; B60W 2520/06; B60Y 2200/92

(57) ABSTRACT

The present disclosure provides a method for controlling driving of a vehicle using driving information of a forward vehicle includes: storing, by a server, driving pattern information of the forward vehicle; updating, by the server, the driving pattern information of the forward vehicle including maximum fuel efficiency; and controlling, by a controller of a following vehicle, driving of the following vehicle based on the driving pattern information of the forward vehicle.

### CROSS-REFERENCE TO RELATED APPLICATION

The present application claims priority to and the benefit of Korean Patent Application No. 10-2016-0148373, filed on Nov. 8, 2016, which is incorporated herein by reference in its entirety.

### FIELD

The present disclosure relates to a control method for a vehicle, and more particularly, to a method for controlling driving of a vehicle using driving information of a forward vehicle.

### BACKGROUND

The statements in this section merely provide background information related to the present disclosure and may not constitute prior art.

An environmentally-friendly vehicle includes a fuel cell vehicle, an electric vehicle, a plug-in electric vehicle, and a hybrid vehicle, and typically includes a motor to generate driving force.

A hybrid vehicle, which is an example of the environmentally-friendly vehicle, uses an internal combustion engine and power of a battery together. In other words, the hybrid vehicle efficiently combines and uses power of the internal combustion engine and power of a motor.

The hybrid vehicle can consist of an engine, a motor, an engine clutch to adjust power between the engine and the motor, a transmission, a differential gear apparatus, a battery, a starter-generator that starts the engine or generates electricity by output of the engine, and wheels.

Further, the hybrid vehicle can consist of a hybrid control unit (HCU) for controlling an entire operation of the hybrid vehicle, an engine control unit (ECU) for controlling an operation of the engine, a motor control unit (MCU) for controlling an operation of the motor, a transmission control unit (TCU) for controlling an operation of the transmission, and a battery control unit (BCU) for controlling and managing the battery.

The battery control unit can be called a battery management system (BMS). The starter-generator can be called an integrated starter and generator (ISG) or a hybrid starter and generator (HSG).

The hybrid vehicle can be driven in a driving mode, such as an electric vehicle (EV) mode, which is an electric vehicle mode using only power of the motor, a hybrid electric vehicle (HEV) mode, which uses rotational force of the engine as main power and uses rotational force of the motor as auxiliary power, and a regenerative braking (RB) mode for collecting braking and inertial energy during driving by braking or inertia of the vehicle through electricity generation of the motor to charge the battery.

Korean Patent Publication No. 10-2013-0058448, which is a related art, is a control method for an environmentally friendly vehicle that efficiently manages charge and discharge of a battery by determining a driving situation in advance using information on an estimated driving route set according to a designation of the vehicle. The related art may analyze a gradient type, a curve road type, and a congestion of a predicted path which are provided by a navigation device so that the related art determines a forward driving situation in advance, thereby performing a charge and discharge control for the battery.

US Patent Application Publication No. US 2014/0249734 A1 which is a related art, processes traffic data and includes a network interface that receives traffic data received from a mobile device and other sources, a memory that stores instructions, and a processor that executes the instructions stored in the memory to collect and validate traffic data. The processor provides the mobile device with traffic information according to user criteria and driving efficiency information. The related art may improve driving performance of a vehicle by sharing the traffic data.

### SUMMARY

The present disclosure provides a method for controlling driving of a vehicle using driving information of a forward vehicle which is capable of increasing driving efficiency (or driving control efficiency) of the vehicle.

One form of the present disclosure may provide the method for controlling driving of the vehicle using driving information of the forward vehicle, including: storing, by a server, driving pattern information of the forward vehicle; updating, by the server, the driving pattern information of the forward vehicle including maximum fuel efficiency; and controlling, by a controller of a following vehicle, driving of the following vehicle based on the driving pattern information of the forward vehicle.

The driving pattern information may include a speed of each forward vehicle, an average value of an acceleration pedal position sensor (APS) value or a brake pedal position sensor (BPS) value of each forward vehicle based on a distance that each forward vehicle travels, and, a standard deviation value of the speed of each forward vehicle, the APS value or the BPS value of each forward vehicle based on the distance that each forward vehicle travels.

The controlling driving of the following vehicle may include: controlling, by the controller the following vehicle, an on state or an off state of an engine of a hybrid vehicle based on the driving pattern information of the forward vehicle when the following vehicle includes the hybrid vehicle.

The method for controlling driving of the vehicle using driving information of the forward vehicle may further include: transmitting, by the forward vehicle, the driving pattern information of the forward vehicle to the server, where the forward vehicle collects the driving pattern information of the forward vehicle based on a predetermined road distance.

The method for controlling driving of the vehicle using driving information of the forward vehicle may further include: transmitting, by the forward vehicle, the driving pattern information of the forward vehicle to the server, where the forward vehicle collects the driving pattern information of the forward vehicle based on a predetermined time.

The method for controlling driving of the vehicle using driving information of the forward vehicle may further include: transmitting, by the controller of the following vehicle, driving pattern information and fuel efficiency of the following vehicle that is used for a vehicle following the following vehicle to the server.

The method for controlling driving of the vehicle using driving information of the forward vehicle according to one form of the present disclosure may detect in advance the driving information to be experienced in the near future by the vehicle in an environment in which the vehicle can communicate with an infrastructure including a repeater (i.e., a network interface) and a server communicating with the repeater, thereby adjusting a transition reference value between a hybrid electric vehicle (HEV) mode and an electric vehicle (EV) mode. Thus, the form of the present disclosure may prevent excessive energy loss of the vehicle.

The other form of the present disclosure may use an optimal driving pattern extracted from a driving environment in front of the vehicle collected from the server while the vehicle is traveling in an environment where the vehicle communicates with the server through the network interface to maximize driving efficiency (or fuel efficiency) of the vehicle.

Further, the other form of the present disclosure may improve performance of the vehicle by sharing the vehicle driving pattern (or the vehicle driving tendency) for each road section.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

A brief description of the drawings will be provided to more sufficiently understand the drawings which are used in the detailed description of the present disclosure.

FIG. 1 is a view explaining a system sharing a driving pattern of a vehicle using a method for controlling driving of the vehicle using driving information of a forward vehicle;

FIG. 2 is a view explaining data communication in the system sharing the driving pattern of the vehicle shown in FIG. 1.

FIG. 3 is a flowchart explaining one form of a method for controlling driving of the vehicle using driving information of the forward vehicle in the system shown in FIG. 1.

FIG. 4 is a table for explaining one form of a method for determining an optimal driving pattern of the vehicle for each road section in the server shown in FIG. 1.

FIG. 5 is a graph for explaining one form of a method for determining an optimal driving pattern of the vehicle for each road section in the vehicle shown in FIG. 1.

FIG. 6 is a view for explaining one form of a method for controlling driving of the vehicle using driving information of the forward vehicle performed by the system shown in FIG. 1 when the road section is determined by a predetermined distance (d).

FIG. 7 is a view for explaining one form of the method for controlling driving of the vehicle using driving information of the forward vehicle performed by the system of FIG. 1 when the road section is determined by a predetermined time (t).

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In order to sufficiently understand the present disclosure, the accompanying drawings illustrating exemplary forms of the present disclosure and contents described in the accompanying drawings are to be referenced.

Hereinafter, the present disclosure will be described in detail by describing exemplary forms of the present disclosure with reference to the accompanying drawings. In describing the present disclosure, well-known configurations or functions will not be described in detail since they may unnecessarily obscure the gist of the present disclosure. Throughout the accompanying drawings, the same reference numerals will be used to denote the same components.

Terms used in the present specification are only used in order to describe specific exemplary forms rather than limiting the present disclosure. Singular forms are to include plural forms unless the context clearly indicates otherwise. It will be further understood that the terms “include” or “have” used in the present specification specify the presence of features, numerals, steps, operations, components, or parts mentioned in the present specification, or a combination thereof, but do not preclude the presence or addition of one or more other features, numerals, steps, operations, components, parts, or a combination thereof.

Throughout this specification and the claims that follow, when it is described that an element is “coupled” to another element, the element may be “directly coupled” to the other element or “electrically or mechanically coupled” to the other element through a third element.

Unless defined otherwise, it is to be understood that the terms used in the present specification including technical and scientific terms have the same meanings as those that are generally understood by those skilled in the art. It must be understood that the terms defined by the dictionary are identical with the meanings within the context of the related art, and they should not be ideally or excessively formally defined unless the context clearly dictates otherwise.

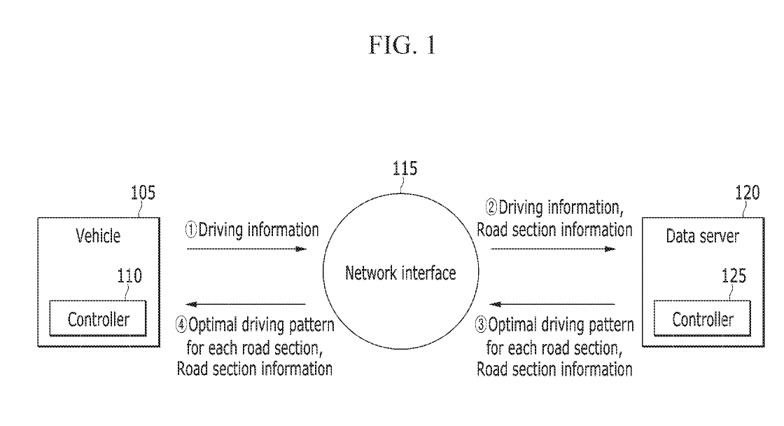

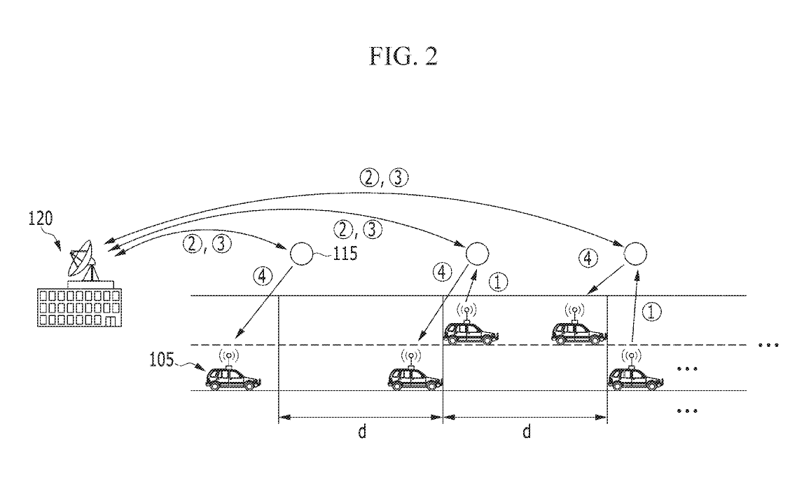

FIG. 1 is a view explaining a system sharing a driving pattern (or a driving tendency) of a vehicle using a method for controlling driving of the vehicle using driving information of a forward vehicle (or a preceding vehicle) according to one form of the present disclosure. FIG. 2 is a view explaining data communication in the system sharing the driving pattern of the vehicle shown in FIG. 1.

Referring to FIGS. 1 and 2, the system may be a system for sharing the driving pattern of the vehicle of each road section. The system may include the vehicle 105, a network interface 115, and a server (or a data server) 120.

A controller 110 of the vehicle 105 may provide the driving pattern (or driving information) of the vehicle 105 to the server 120 via the network interface 115. The controller 110 may also be referred to as a data processor. For example, the controller 110 may be one or more microprocessors operated by a program or hardware including the microprocessor. The program may include a series of commands for executing the method for controlling driving of the vehicle using driving information of the forward vehicle according to one form of the present disclosure, which will be described below. The controller 110 may control an entire operation of the vehicle 105.

Each vehicle 105 may calculate the driving pattern for each road section using driving data of each vehicle. The driving pattern may be data representing a driving state of each vehicle according to a road section. The driving pattern of each road section calculated in each vehicle may be shared through a network including the network interface 115. When the vehicle 105 may enter a road section in front of the vehicle, the vehicle may receive in advance the driving pattern of the front road section to enter an optimal control state.

The network interface 115 such as a repeater may transfer the driving information for each road section. The server 120 may communicate with the network interface 115 using the repeater identification.

A controller 125 of the server 120 may collect driving pattern information from a plurality of vehicles including the vehicle 105 through the network interface 115 to extract optimal driving pattern information for each road section. The controller 125 may control an entire operation of the server 120. The controller 125 may also be referred to as a data processor. The driving pattern information may be continuously updated.

The driving pattern information in each road section of each vehicle 105 may be transmitted to the data server 120 via the network, the data server may collect driving pattern data of the vehicles in each road section so that the data server determines an optimal driving pattern for each road section and transfers the determined optimal driving pattern to each vehicle travelling on each road section, and each vehicle may perform optimal driving control according to the optimal driving pattern.

The driving information transmitted from the vehicle 105 to the network interface 115 may include the driving pattern in each road section, fuel efficiency of the vehicle in each road section, or a current position of the vehicle. Road section information transmitted from the vehicle 105 to the network interface 115 may include a position of a road section or road section state information (e.g., state information indicating whether a signal is transmitted and received in the road section). The optimal driving pattern information for each road section may be transmitted from the data server 120 to the vehicle 105 through the network interface 115.

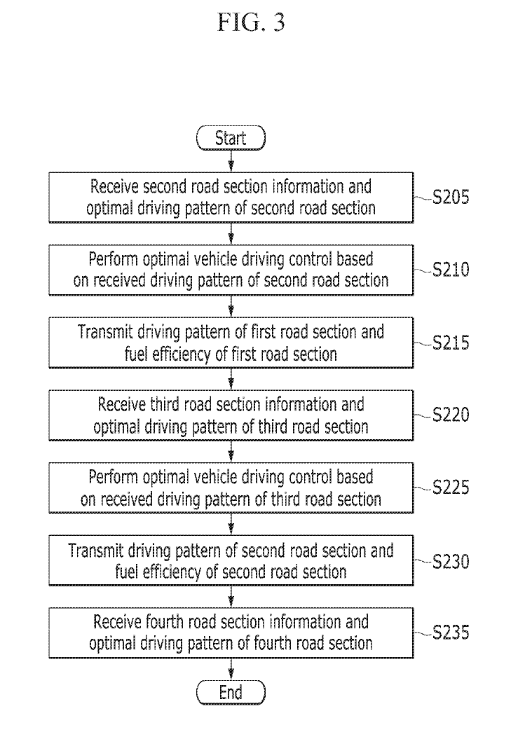

FIG. 3 is a flowchart explaining one form of the method for controlling driving of the vehicle using driving information of the forward vehicle in the system shown in FIG. 1.

Referring to FIG. 3, in a receiving step S205, the vehicle 105, which may be a following vehicle, may receive information on a second road section located in front of a first road section and an optimal driving pattern of the second road section in the first road section.

According to a control step 5210, the vehicle 105 may perform an optimal vehicle driving control in the second road section based on the driving pattern of the received second road section including maximum fuel efficiency.

According to a transmission step S215, after the control step S210, the vehicle 105 may transmit the driving pattern of the vehicle in the first road section and fuel efficiency of the vehicle in the first road section that may be used for a following vehicle following the vehicle 105 to the server 120 via the network interface 115. The server 120 may update (or store) information on the first road section to a driving pattern stored in the server 120 and may check the driving pattern information of the second road section to be transmitted to the vehicle 105. The server 120 may calculate an optimal driving pattern in the first road section to be used in a vehicle following the vehicle 105.

According to a receiving step S220, the vehicle 105 may receive information on a third road section located in front of the second road section and an optimal driving pattern of the third road section in the second road section.

According to a control step S225, the vehicle 105 may perform an optimal vehicle driving control in the third road section based on the driving pattern of the received third road section including maximum fuel efficiency.

According to a transmission step S230, after the control step S225, the vehicle 105 may transmit the driving pattern of the vehicle in the second road section and fuel efficiency of the vehicle in the second road section that may be used for a following vehicle following the vehicle 105 to the server 120 via the network interface 115. The server 120 may update (or store) information on the second road section to a driving pattern stored in the server 120 and may check the driving pattern information of the third road section to be transmitted to the vehicle 105. The server 120 may calculate an optimal driving pattern in the second road section that is used in a vehicle following the vehicle 105.

According to a receiving step S235, the vehicle 105 may receive information on a fourth road section located in front of the third road section and an optimal driving pattern of the fourth road section in the third road section.

One form of the present disclosure may perform steps similar to the control step S225 and the transmission step S230 after the receiving step S235.

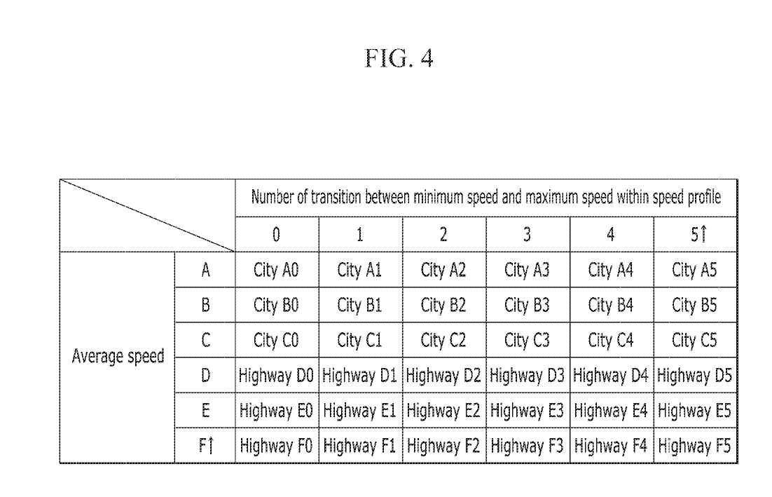

FIG. 4 is a table for explaining an exemplary form of a method for determining (or calculating) an optimal driving pattern of the vehicle for each road section in the server shown in FIG. 1.

Each vehicle 105 may collect a driving pattern (e.g., an average speed of the vehicle on each road section, number of transition between a minimum speed and a maximum speed included in a speed profile in each road section of the vehicle, or fuel efficiency of the vehicle) that is driving data of the vehicle in each road section, and may classify driving characteristics of each road section as the driving pattern shown in FIG. 4.

In another form of the present disclosure, the average speed of the vehicle that is the driving data may be replaced as the vehicle speed, an average value of an acceleration pedal position sensor (APS) value of the vehicle in each road section, an average value of an brake pedal position sensor (BPS) value of the vehicle in each road section, or a combination of the vehicle speed, the average value of the APS value, and the average value of the BPS value, and the number of transition between the minimum speed and the maximum speed that is the driving data may be replaced as the vehicle speed, an standard deviation value of the APS value in each road section, an standard deviation value of the BPS value in each road section, or a combination of the vehicle speed, the standard deviation value of the APS value, and the standard deviation value of the BPS value.

The driving pattern of each vehicle may be collected in the server 120 and may be statistically analyzed in the server 120. The driving pattern of each vehicle may be compared with a driving pattern having a representative driving pattern of each road section, thereby being determined whether a road on which the vehicle travels is congested. For example, if a road section is classified as City A3 based on a result of the statistical analysis when the road section is classified as City A1 according to a road type, the road section may be determined to be congested. Increase of a number in the classified road section may indicate deepening of congestion. In more detail, as shown in FIG. 4, degree of congestion of the road section may be detected by the driving pattern. In FIG. 4, City may indicate a street in a downtown, and Highway may indicate a highway.

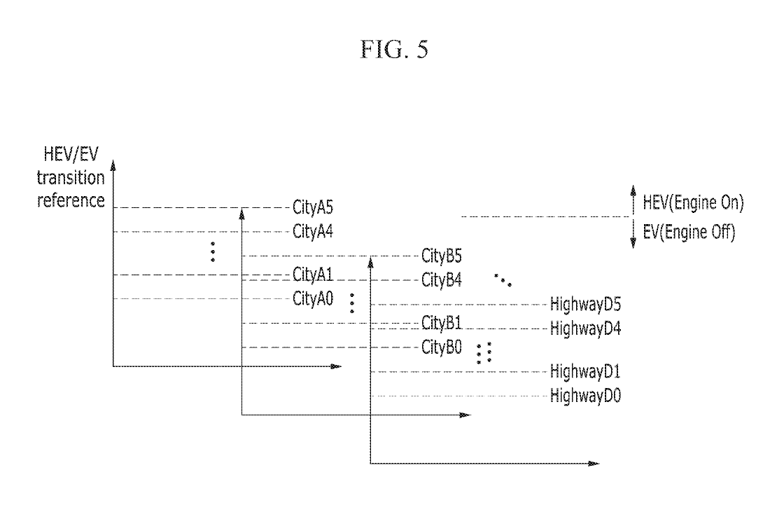

FIG. 5 is a graph for explaining one form of a method for determining an optimal driving pattern of the vehicle for each road section in the vehicle shown in FIG. 1. In the graph of FIG. 5, a horizontal axis may indicate a time.

When the vehicle 105 includes a hybrid vehicle (or a hybrid electric vehicle) having multiple power sources that are an engine and a motor, the vehicle may vary a transition reference value between a hybrid electric vehicle (HEV) mode and an electric vehicle (EV) mode based on the optimal driving pattern of each road section received from the server 120. Thus, the engine may not be unnecessarily turned on or off. For example, because a road type such as City A5, City B5, or Highway F5 is a congested road section, the EV mode may satisfy driving performance of the vehicle. Thus, the transition reference value shown in FIG. 5 may be controlled to be increased so that the engine may not be unnecessarily turned on or off,

The hybrid vehicle may use the engine (e.g., a diesel engine) and the motor (or a driving motor) as power sources, and may include an engine clutch existing between the engine and the motor so that the hybrid vehicle may be operated in the EV mode in which the hybrid vehicle travels by the motor in a state where the engine clutch is opened, and in the HEV mode in which the hybrid vehicle is capable of travelling by both the motor and the engine in a state where the engine clutch is closed. The vehicle 105 may enter into the HEV mode for operating the engine of the hybrid vehicle when the vehicle is in a mode equal to or greater than the transition reference value, and the vehicle may maintain the EV mode turning off the engine when the vehicle is in a mode less than the transition reference value. The transition reference value may be the vehicle speed, torque required by a driver of the vehicle, or the driver requested power.

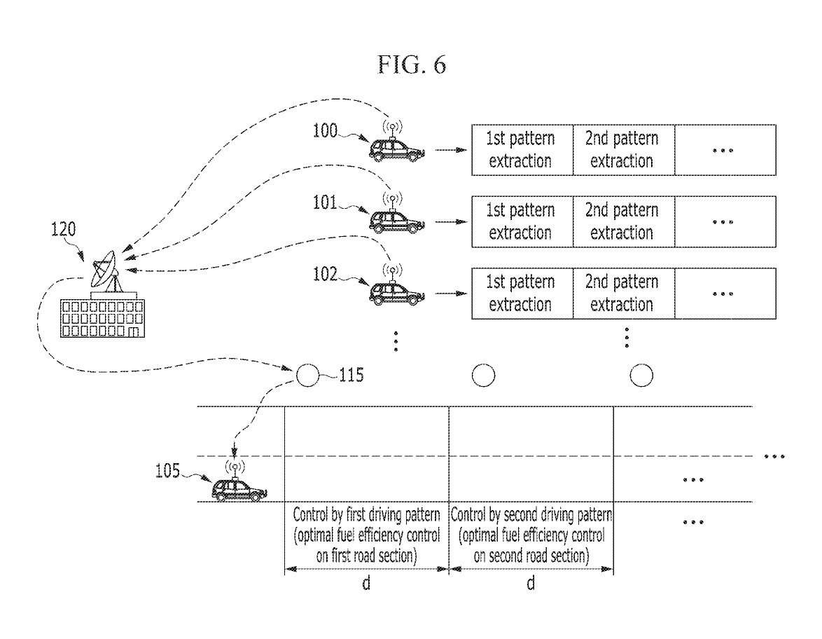

FIG. 6 is a view for explaining one form of a method for controlling driving of the vehicle using driving information of the forward vehicle performed by the system shown in FIG. 1 when the road section is determined by a predetermined distance (d).

Referring to FIG. 6, a first vehicle 100, a second vehicle 101, and a third vehicle 102 included in the forward vehicle may transmit (or provide) the vehicle driving information (or driving pattern information of the vehicle) to the server 120. For example, the driving pattern information may include the vehicle speed, the APS value of the vehicle, the BPS value of the vehicle, a gear shift stage of the vehicle, a current position of the vehicle, or fuel efficiency of the vehicle in a road section. The driving pattern information may be transmitted to the network interface 115 after each occurrence of a predetermined distance (d).

The server 120 may collect the driving pattern information and may extract (or calculate) the driving pattern information including maximum fuel efficiency in each pattern calculation period corresponding to the specific distance (d).

The server 120 may transmit information on a road section on which the following vehicle 105 travels and the driving pattern information including maximum fuel efficiency to the following vehicle via the network interface 115. For example, the information of the road section may include a position of the road section.

The following vehicle 105 may perform a driving control with optimal fuel efficiency in each specific distance (d) and may calculate (or collect) its own driving pattern information.

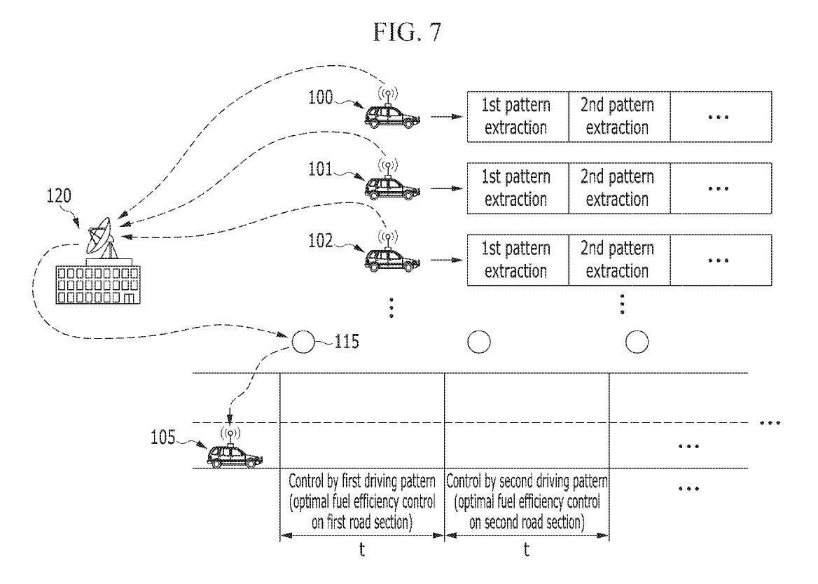

FIG. 7 is a view for explaining one form of a method for controlling driving of the vehicle using driving information of the forward vehicle performed by the system of FIG. 1 when the road section is determined by a predetermined time (or a predetermined time interval) (t).

Referring to FIG. 7, the first vehicle 100, the second vehicle 101 and the third vehicle 102 included in the forward vehicle may transmit (or provide) the vehicle driving information (or driving pattern information of the vehicle) to the server 120. For example, the driving pattern information may include the vehicle speed, the APS value of the vehicle, the BPS value of the vehicle, a gear shift stage of the vehicle, a current position of the vehicle, or fuel efficiency of the vehicle in a road section. The driving pattern information may be transmitted to the network interface 115 after each occurrence of a predetermined time (t).

The server 120 may collect the driving pattern information and may extract (or calculate) the driving pattern information including maximum fuel efficiency in each pattern calculation period corresponding to the specific time (t).

The server 120 may transmit information on a road section on which the following vehicle 105 travels and the driving pattern information including maximum fuel efficiency to the following vehicle via the network interface 115. For example, the information of the road section may include a position of the road section.

The following vehicle 105 may perform a driving control with optimal fuel efficiency in each specific time (t) and may calculate (or collect) its own driving pattern information. When the vehicle driving pattern information according to specific time (t) is extracted, a distance traveled by the vehicle may be varied.

The components, “˜unit”, block, or module which are used in the present exemplary form may be implemented in software such as a task, a class, a subroutine, a process, an object, an execution thread, or a program which is performed in a predetermined region in the memory, or hardware such as a field programmable gate array (FPGA) or an application-specific integrated circuit (ASIC), and may be performed with a combination of the software and the hardware. The components, ‘˜part’, or the like may be embedded in a computer-readable storage medium, and some part thereof may be dispersedly distributed in a plurality of computers.

The description of this disclosure is merely exemplary in nature and, thus, variations that do not depart from the substance of the disclosure are intended to be within the scope of the disclosure. Such variations are not to be regarded as a departure from the spirit and scope of the disclosure,

What is claimed is:

1. A method for controlling driving of a second vehicle using driving pattern information of a first vehicle, comprising:
storing, by a server, the driving pattern information of the first vehicle, wherein the first vehicle is a forward vehicle driving ahead of the second vehicle;
updating, by the server, the driving pattern information of the first vehicle, wherein the driving information of the first vehicle comprises maximum fuel efficiency; and
controlling, by a controller of the second vehicle, the driving of the second vehicle based on the driving pattern information of the first vehicle, wherein the second vehicle is a following vehicle driving behind the first vehicle.

2. The method of claim 1, wherein the driving pattern information of the first vehicle comprises:
a speed of each vehicle of a plurality of forward vehicles;
an average value of an acceleration pedal position sensor (APS) value or a brake pedal position sensor (BPS) value of each vehicle of the plurality of forward vehicles based on a distance that each vehicle of the plurality of forward vehicles travels; and
a standard deviation value of the speed of each vehicle of the plurality of forward vehicles, the APS value or the BPS value of each vehicle of the plurality of forward vehicles based on the distance that each vehicle of the plurality of forward vehicles travels.

3. The method of claim 1, wherein controlling the driving of the second vehicle comprises:
when the second vehicle includes a hybrid vehicle, controlling, by the controller of the second vehicle, an on-state or an off-state of an engine of the hybrid vehicle based on the driving pattern information of the first vehicle.

4. The method of claim 1, further comprising:
transmitting, by the first vehicle, the driving pattern information of the first vehicle to the server, wherein the first vehicle collects the driving pattern information of the first vehicle based on a predetermined road distance.

5. The method of claim her comprising:
transmitting, by the first vehicle, the driving pattern information of the first vehicle to the server, wherein the first vehicle collects the driving pattern information of the first vehicle based on a predetermined time.

6. The method of claim 1, further comprising:
transmitting, by the controller of the second vehicle, driving pattern information of the second vehicle to the server, wherein the driving pattern information of the second vehicle comprises fuel efficiency of the second vehicle, and wherein the driving pattern information of the second vehicle is used for a vehicle driving behind the second vehicle.
